(19) United States
(12) Patent Application Publication
(10) Pub. No.: US 2012/0141962 A1
(43) Pub. Date: Jun. 7, 2012

(54) SYSTEMS AND METHODS FOR MATCHING A PATIENT WITH A MENTAL HEALTH CARE PROVIDER

(76) Inventor: Gabrielle R. Williamson, Springboro, OH (US)

(21) Appl. No.: 13/153,657

(22) Filed: Jun. 6, 2011

Related U.S. Application Data
(60) Provisional application No. 61/352,078, filed on Jun. 7, 2010.

(51) Int. Cl. G09B 19/00

(52) U.S. Cl. 434/236

(57) ABSTRACT

Systems and methods to match a user to a mental health care provider. Answers to user and provider assessment questionnaires are used to generate a bond index score. The bond index score indicates the strength of a potential therapeutic bond formed between the user and the provider.

### CROSS REFERENCE TO RELATED APPLICATIONS

The present application claims priority to U.S. Provisional Application No. 61/352,078, entitled “Systems and Methods for Effectively Aligning a Patient with a Doctor” and filed Jun. 7, 2010, the entirety of which is incorporated by reference.

### FIELD OF THE INVENTION

One or more embodiments shown and described herein relates generally to systems and methods that match individuals. Specifically, one or more embodiments relates to systems and methods of identifying and providing communication avenues between users and mental health professionals as well as providing improved systems and methods for users to locate, identify, and/or determine a proper mental health professional with whom they are likely to have a successful therapeutic relationship.

### BACKGROUND OF THE INVENTION

More than 50 million Americans suffer from one or more mental health illnesses. Locating a professional is often achieved through word-of-mouth referrals, “thumbing” through, and blindly choosing a professional from the Yellow Pages™, as well as basic online “hunting and pecking.” This system of rummaging for quality mental health care has resulted in “hit” (successful) or “miss” (unsuccessful) therapy appointments due to mismatches between a mental health professional and a user, either prolonging the hunt or providing a less successful user/mental health professional relationship due to the randomness of the current processes.

### SUMMARY OF THE INVENTION

In one embodiment, a computerized method for matching a user and a mental health professional is disclosed. The method includes receiving, at one or more processors, user response data indicative of responses to a user assessment questionnaire by a user. The method also includes retrieving, from a memory, provider response data indicative of responses to a health care provider assessment questionnaire by a mental health professional. The method further includes using the user response data and the provider response data to generate a bond index score and using the bond index score to select the mental health professional. The method additionally includes providing an indication of the selection to a user interface device.

In another embodiment, matching engine for matching a user and a mental health professional is disclosed. The matching engine includes one or more processors and a non-transitory memory operatively connected to the one or more processors. The memory stores instructions that, when executed by the one or more processors, cause the one or more processors to receive user response data indicative of responses to a user assessment questionnaire by a user and to retrieve provider response data indicative of responses to a health care provider assessment questionnaire by a mental health professional. The instructions further cause the one or more processors to generate a bond index score using the user response data and the provider response data, to use the bond index score to select the mental health professional, and to provide an indication of the selection to a user interface device.

In a further embodiment, a non-transitory computer-readable medium is disclosed. The medium includes instructions that, when executed by one or more processors, cause the one or more processors to receive user response data indicative of responses to a user assessment questionnaire by a user and to receive provider response data indicative of responses to a health care provider assessment questionnaire by a mental health professional. The instructions also cause the one or more processors to generate a bond index score using the user response data and the provider response data, use the bond index score to select the mental health professional, and to provide an indication of the selection and contact information for the mental health professional to a user interface device.

### BRIEF DESCRIPTIONS OF DRAWINGS

The following detailed description of the embodiments of the present disclosure can best be understood when read in conjunction with the following drawings, where like structure is indicated with like reference numerals.

FIG. 1 illustrates an electronic system to unite a user and a mental health professional, according to embodiments shown and described herein.

FIG. 2 illustrates a method for matching a user to a mental health professional, according to embodiments shown and described herein.

FIG. 3 is a schematic diagram of the matching engine shown in FIG. 1, according to embodiments shown and described herein.

The embodiments set forth in the drawing are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION

Not to be limited by theory, two of the most important factors contributing to successful mental health treatment are finding access to a professional and developing a positive bond with the mental health professional. Complicating such matters even more, the majority of researchers agree that the number one factor determining the success of mental health treatment is the “therapeutic bond.” As used herein, “therapeutic bond” means the working relationship between mental health professional and user. Furthermore contemporary theories of psychotherapeutic change now emphasize the importance of the alliance, so much so, that many theorists have referred to the alliance as the “quintessential integrative variable.” When clients come to therapy, they expect to find mental health professionals with whom they can develop a close relationship. Applicant has discovered that due to the randomness of the current matching processes, the odds of achieving a successful therapeutic bond are fairly low.

The systems and methods shown and described herein will take the guesswork out of selecting a mental health professional. Additionally, the systems and methods improve user outcomes by improving access to mental health professionals. The systems and methods will enhance the lives of individuals in need of mental health services by improving their ability to find a mental health professional with whom they will form a successful therapeutic bond and thus receive successful care. Also, the systems and methods herein empower those seeking mental health care to locate the best mental health professional. Such systems and methods will match prospective users with a mental health professional based on important dimensions and/or criteria of rapport as this bond is much too important to leave to random selection methods. The systems and methods utilize a bond index score to determine an appropriate mental health professional with whom a successful therapeutic bond may be formed with the user. Once the systems and methods using the bond index score successfully connect a user to a professional, treatment can be achieved efficiently and effectively due to a strong therapeutic bond. The systems and methods enable proper entry into treatment allowing both the user and the mental health professional to feel comfortable with the relationship. They remove blind choice, while enhancing anonymity and privacy while a user is searching for a mental health professional.

The systems and methods may be the first place to turn for help. The systems and methods shown and described herein are each a safe, reliable, anonymous, credible connector of users to mental health professionals. By using the deeper dimensions of successful therapeutic bonds, in addition to techniques to help create patient-health professional alliances, the systems and methods ensure the greatest chance of success from the outset.

### Definitions

As used herein, the following terms are defined as follows:

“Mental health care provider” and “mental health care professional,” are used synonymously throughout the present application to refer to a licensed mental health practitioner, such as a psychiatrist, psychologist, therapist, counselor, psychoanalysts, and the like.

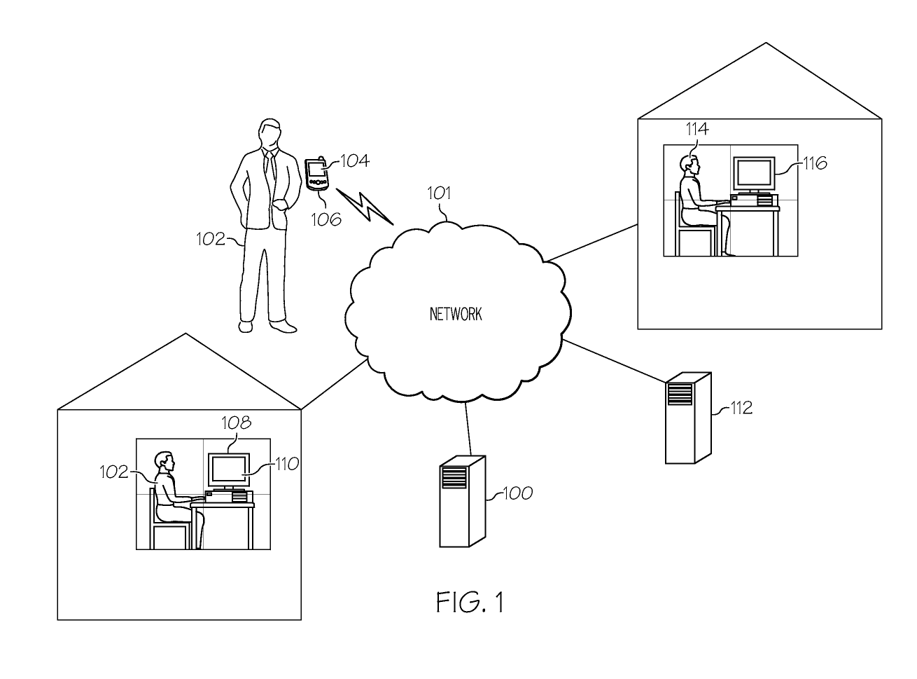

Referring now to FIG. 1, an illustration of an electronic system to unite a user and a mental health professional is shown, according to an illustrative embodiment. As shown, a user 102 seeking mental health care may interact with a computing device, in order to be matched to a mental health care provider 114. An initial user assessment questionnaire and an initial provider assessment questionnaire are used to match users (e.g., potential patients) with mental health providers. The user's initial assessment responses results in a clinical profile (e.g., a set of answers to the user assessment questionnaire). Similarly, the mental health providers who have opted to participate in the system complete mental health care provider assessment questionnaires. The provider response data from a provider assessment questionnaire results in a model-of-care profile (e.g., a set of answers associated with a particular provider). The system compares the clinical profile with model-of-care profiles to generate a set of one or more mental health care providers who are candidates for having a strong therapeutic bond with the individual user.

As shown, network 101 connects a number of computing devices, thereby facilitating the matching process. Network 101 may include any number of hardwired connections (e.g., via fiber optic cables, coaxial cables, CATS cables, or any other wired connection capable of conveying electronic data) and/or any number of wireless connections (e.g., via radio frequency, a WiFi connection, a cellular network, or any other wireless connection capable of conveying electronic data). In some embodiments, network 101 may provide a direct connection between computing devices. In other embodiments, network 101 may provide an indirect connection and include any number of intermediary computing devices (e.g., routers, servers, switches, and the like) that are used to convey data between the computing devices connected to network 101.

User 102 interacts with a computing device connected to network 101, in order to be matched with mental health care provider 114. For example, user 102 may interact with home computing device 110 (e.g., a desktop personal computer, or the like) or mobile computing device 106 (e.g., a smartphone, a tablet PC, a laptop computer, or the like) to participate in the matching process. In some embodiments, mobile computing device 106 and/or home computing device 110 initiates the matching process by communicating with matching engine 100 via network 101 to request a user assessment questionnaire. In other embodiments, the user assessment questionnaire may be preloaded onto mobile computing device 106 and/or home computing device 110 and the matching process is initiated by user 102 requesting to complete the questionnaire. In either case, the questionnaire is presented to user 102 via user interface device 104 (e.g., a display, a speaker, or the like) of mobile computing device 106 or via user interface device 108 (e.g., a display, a speaker, or the like) of home computing device 110 to be completed. In general, the user assessment questionnaire includes one or more questions that may be relevant to establishing a therapeutic bond between user 102 and mental health care provider 114.

Mental health care provider 114 interacts with provider computing device 116 (e.g., a mobile or desktop computing device), to answer a health care provider assessment questionnaire. The health care provider assessment questionnaire may be preloaded onto provider computing device 116 or retrieved from matching engine 100 via network 101. Similar to the user assessment questionnaire, the health care provider assessment questionnaire includes one or more questions that may be relevant to establishing a therapeutic bond between user 102 and mental health care provider 114, but tailored to the perspective of a mental health care provider. For example, mental health care provider 114 may be asked questions about her areas of expertise, therapeutic approaches, communication style, personality traits, etc., that can be used to help match her to prospective patients.

Matching engine 100 receives data indicative of the responses to the user assessment questionnaire and the health care provider assessment questionnaire from mobile computing device 106, home computing device 110, and/or provider computing device 116. Matching engine 100 stores the response data from the health care provider assessment questionnaire sets of responses for a plurality of mental health care providers. In response to receiving the response data from the user assessment questionnaire, matching engine 100 utilizes the received user answer data and the sets of provider responses to generate one or more bond index scores between the user answer data and a provider's answer data. In general, a bond index score indicates the likelihood of user 102 forming a therapeutic bond with a mental health care provider, such as health care provider 114. For example, matching engine 100 may use empirical data and scales such as the Alliance Bond Scale to identify the potential mental health professionals with the highest likelihood of achieving a therapeutic bond with user 102 to deliver an optimal therapeutic outcome for her. In some cases, additional filters may also be applied prior to, during, or after matching engine 100 generates the bond index scores, in order to further limit the set of matched health care providers. For example, bond index scores may be generated only for those health care providers that are within a specific geographic location or within a specified distance to user 102.

Matching engine 100 utilizes the bond index scores to determine a set of one or more matched mental health care providers and provides the set to mobile computing device 106 and/or home computing device 110. The matched mental health care providers are then reviewed by user 102 via user interface device 104 and/or user interface device 110. In some embodiments, matching engine 100 may also provide contact information (e.g., a mailing address, a phone number, a fax number, an email address, instant message, a link to a social media website, a wall message platform, or the like) for mental health care provider 114 to mobile computing device 106 and/or home computing device 110. If possible, user 102 may also utilize mobile computing device 106 and/or home computing device 110 to initiate contact with health care provider 114 or to schedule an appointment with health care provider 114.

In some embodiments, matching engine 100 also communicates with other computing devices 112 (e.g., other servers, mobile devices, computers, or the like), to provide additional functionality in the matching process. For example, a secondary user (e.g., a friend, loved one, or other user authorized by user 102) may utilize other computing devices 112 to participate in the matching process for the primary user. User 102 may authorize the secondary user to provide additional data about user 102 to matching engine 100, view contact and other information about mental health care provider 114, view the list of matching health care providers, and/or indicate a preferred provider from among the list of matching health care providers. Other computing devices 112 may also provide insurance information to matching engine 100 (e.g., which providers participate in a particular insurance network) or convey information about the matching process to another health care provider associated with user 102 (e.g., the primary care physician of user 102, or the like). In addition, other computing devices 112 may house an online presence for mental health care provider 114 (e.g., as part of a social media website, a bulletin board system, or the like) that can be access by user 102 to communicate with mental health care provider 114 and/or to schedule an appointment with them.

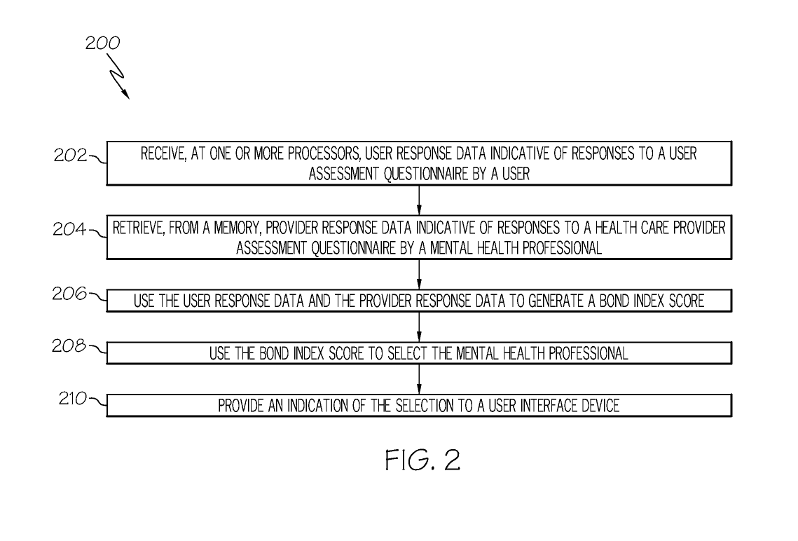

Referring now to FIG. 2, method 200 for matching a user to a mental health care professional is shown, according to an exemplary embodiment. Method 200 includes receiving, at one or more processors, user response data indicative of responses to a user assessment questionnaire by a user (block 202). The user assessment questionnaire may include any number of true or false questions, multiple choice questions, questions that use a Likert-type scale, open-ended questions, and the like. The user response data may include general information about the user, such as the user's age, gender, address, education, occupation, insurance information, medical history, or geographic location. User response data may also include additional information about the user, such as information about the user's family history, a reason the user is seeking help, a symptom experienced by the user, the user's change management style, and/or a reason the user may avoid seeking therapy.

Family history information includes information about the user's family that may be relevant to the treatment of the user and/or relevant to the matching process. Family history information may be relevant to the diagnosis of mental conditions that have a potential genetic link. For example, user response data may include responses to questions such as “Does depression run in your family?” or “Did your mother suffer from post-partum depression?” Such information may be used to match the user to a therapist that specializes in the treatment of such conditions. In some embodiments, other family history information may be used to enhance the therapeutic bond between the user and a therapist. For example, a user that was adopted may have a higher chance of forming a therapeutic bond with a health care provider that was also adopted.

User response data may also include one or more responses as to why the user is seeking help. In general, these responses relate to the impetus behind the user seeking treatment. In one example, the user may be seeking treatment at the behest of a family member or friend. In another example, the user may be seeking treatment because her work or social life has been impacted. Similarly, the user response data may also include one or more responses about symptoms experienced by the user. In some cases, one or more symptoms may be the reason the user is seeking treatment, while in other cases, they may be part of the overall impetus to seek treatment. For example, user response data in this category may include answers such as “I want to focus on obsessive behaviors” or “I want to focus on discussing hopelessness.”

User response data may further include one or more responses about the user's change management style. In general, change management describes the reactions and approaches taken by a user to enact a change in her life. For example, user response data in this category may include answers to questions such as “Do you rely on friends or family to implement a change in your life?” and “Do you prefer gradual change or rapid change?”

User response data may also include answers that fall within a roadblock category, i.e., one or more reasons why the user may avoid seeking therapy. In general, a user may have certain apprehensions or other considerations that may prevent the user from actually scheduling an appointment with a mental health care provider. For example, user response data in this category may include answers such as “I fear being judged by my family,” “I am afraid that I will not be able to afford treatment,” or “I fear being judged by my mental health professional.”

An additional category of user response data may relate to the user's personality. Under the personality category, a user's specific personality factors, such as attachment style and behaviors, may be assessed for their influence on the therapeutic bond. For example, a sample answer in this category may include the following open-ended statement: “In making a decision, I often let my emotions be the key factor in determining what I should do.”

In addition to the previously listed categories, the user response data may also include additional factors that may influence the user's therapeutic experience. For example, the user response data may further include answers to questions regarding the user's preferences in selecting a mental health care provider. For example, the user response data may include a user's preference as to the health care provider's background (including education), gender, age, language spoken, specific setting (such as office or meeting hall), or type (such as psychologist, social worker, psychiatrist, or the like.). Other types of user response data may also fall within a relationship category that addresses specific factors of successful therapeutic relationships. This category may include analysis of similarity versus opposite issues, values, life experiences, and forms of communication (e.g., languages spoken). In one embodiment of the invention, an additional area that may be assessed in the relationship variables category relates to the similarity versus opposite dichotomy, which describes the concept that opposites attract or similar people attract. If a user or mental health professional is open to the idea that opposites attract, their respective answers to the question may be weighted differently than a user or mental health professional who is not open to the concept. A more similar mental health professional is matched with the user who does not believe in “opposites attracting.” For example, the user data may include answers to a question such as “Do you believe complete opposites can have healthy, long-term relationships?” Other answers may indicate life experiences of the user that may create a common bond in the therapeutic relationship, such as being a war veteran or a survivor of abuse.

Method 200 also includes retrieving, from a memory, provider response data indicative of responses to a health care provider assessment questionnaire by a mental health professional (204). Similar to the user assessment questionnaire, a health care provider assessment questionnaire contains a series of questions that are relevant to the establishment of a therapeutic bond. In some embodiments, the user assessment questionnaire and the health care provider assessment questionnaire may have the same or similar questions in the categories described previously with respect to the user assessment questionnaire. For example, provider response data may include answers to general questions such as the provider's age or education. In other examples, the provider response data may include answers related to a provider's area of expertise, how the mental health professional would encourage a patient to change their behavior, or how the mental health professional would address why the patient may avoid seeking therapy.

In some cases, the provider response data may include responses that describe which topics and areas of therapy in which the mental health professional spends most of his professional time. This category of responses may correlate to the user's “symptoms” and “issues of concern” categories, described previously. For example, the provider response data may include responses such as “I focus on obsessive behaviors” and “I focus on discussing feelings of hopelessness.”

The provider response data may also include responses that fall within a change management category. In general, provider responses in the change management category describe the theories and tactics that the mental health professional uses to encourage and cause change in the user's behavior during treatment. For example, the provider response data may include an answer to an open-ended question such as “I approach change this way . . . ,” to capture the change management style of the mental health professional.

Similar to the user response data, the provider response data may also include answers to questions that fall within a roadblock category. In general, answers in the provider response data that fall within the roadblock category relate to how the mental health professional would address why the patient may avoid seeking therapy. In some embodiments, the provider response data in this category may include answers as to how the mental health professional would handle the perceptions of users or assuage a user's fears about seeking treatment. For example, the provider response data may include an answer to a question such as, “How would you approach a patient that fears being judged by their therapist?”

The provider response data may also include answers to questions that fall within a model of care category. In general, the model of care category concerns the preferred methods by which professionals administer mental health care. For example, questions in this category may be directed towards the provider's goals for change, therapy types, therapeutic orientation, mode of therapy, and care techniques. Goals for change and therapy types generally relate to how the mental health provider (and user) sets and achieves therapeutic goals. The therapeutic orientation of the mental health provider addresses the psychology theory or theories to which the mental health provider subscribes. A mode of therapy includes how the provider interacts with a patient (e.g., via individual therapy, group therapy, or couples therapy). Care techniques include additional information about how a provider tailors therapy to an individual patient.

Method 200 further includes using the user response data and the provider response data to generate a bond index score (206). The bond index score provides a measure of how strong a therapeutic bond may be between a user and a mental health professional (e.g., as a number, a percentage, or the like). For purposes of illustration only, a “high” bond index score will be used hereinafter to denote a strong therapeutic bond. However, it is to be understood that any relative numbering system may be used for the bond index score. For example, the bond index score may be ranked on scale of −100 to +100, where −100 denotes the strongest therapeutic bond, without deviating from the scope of the present application.

In general, the personality-related answers from the user and the types of therapies offered by the health care provider may be used to determine if a provider has a high bond index score with a user. In one embodiment, a correlation matrix may be generated using the provider response data and the user response data to show the level of correlation between the variables produced by the user initial assessment and the mental health professional initial assessment. The correlation level then may, in turn, be used to generate a bond index for the user with respect to one or more mental health professionals. For example, the degree of correlation between a particular user answer and a provider answer may vary from negative one (−1.0) to positive one (1.0), with a value of 1.0 indicating a high degree of correlation between the two assessment responses. In some cases, the resulting correlation matrix may indicate a linear relationship between the provider response data and the user response data. In other cases, a nonlinear relationship may exist between the provider response data and the user response data. Any number of techniques may be used to analyze a nonlinear relationship, such as curve-fitting techniques or performing mathematical transformations (e.g., taking the logarithm of one variable, etc.). In some embodiments, the correlation matrix may be examined to identify combinations of correlated variables (e.g., answers) that are commonly called factors and identified through factor analysis. Factor analysis combines multiple variables into a single factor in order to reduce the total number of variables that must be considered. In cases where answers in the user response data do not have direct counterpart answers in the provider response data, such responses can also be used to generate a raw number which can then be used to assist in determining the bond index score.

In some embodiments, weighting factors may also be used as part of the bond index calculation. The weighting factors will be assigned based upon the relative impact that the identified counterpart responses will have on the therapeutic relationship. For example, the impact may be positive, which would result in a higher bond index score, or it may be negative, which will result in a correspondingly lower bond index score. For example, the correlation between the specialization of a provider and the symptoms of a user may be emphasized via a weighting factor, whereas the correlation between the ages of the user and a provider may be deemphasized. In some embodiments, the weighting factors may be based on the Alliance Bond Scale or another clinical measure of the strength of a therapeutic bond. In a non-limiting example, the bond index may be calculated as follows:

C=Σwi Fi (Equation 1)

where C equals the approximated bond index, Fi equals the ith factor, and wi equals the weighting of factor Fi.

In other embodiments, the bond index score may be generated using decision trees, digraphs with weighted edges, if weighting factors are used, a neural network, or any other computerized technique. For example, users and/or providers may be presented with a follow-up questionnaire that asks them to rate the therapeutic bond. Such a questionnaire may be used to train the neural network to better generate bond index scores. In further embodiments, filters may be applied to the user and provider response data prior to, during, or after generation of the bond index score. For example, a filter may be applied that limits the scored providers to those providers that are located within a certain distance of the user.

Method 200 also includes using the generated bond index score to select the mental health professional (208). In some embodiments, only the professional having the highest bond index score is selected, while in other embodiments, a set of the professionals having the highest index scores may be selected.

Method 200 additionally includes providing an indication of the selection to a user interface device (e.g., an electronic display, a speaker, or the like) (210). The indication may include, for example, the name of a selected mental health professional, a picture of the professional, and/or the contact information of the professional (e.g., a street address, a phone number, an email address, a profile on a social media platform/website, an instant message screen name, or the like).

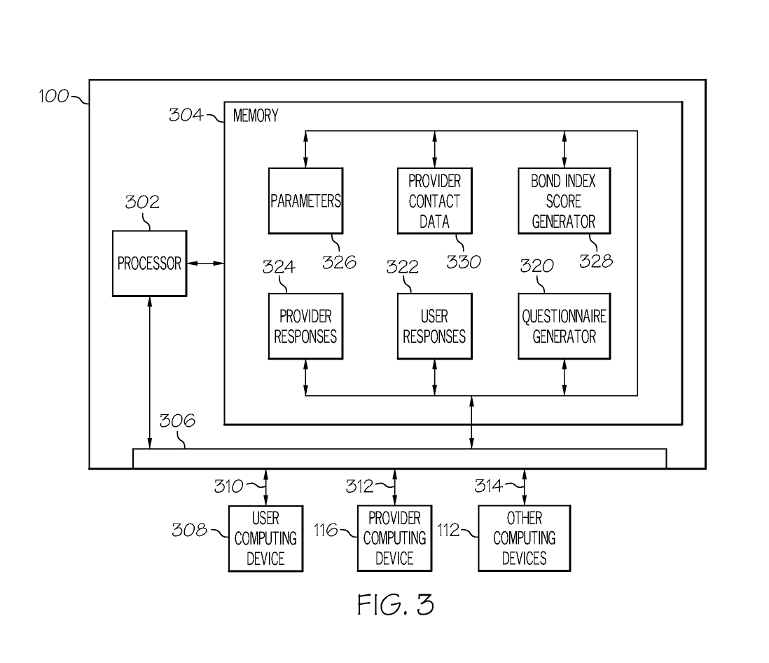

Referring now to FIG. 3, a schematic illustration of matching engine 100 is shown, according to embodiments shown and described herein. Matching engine 100 includes processor 302, which may be one or more processors (e.g., a microprocessor, an application specific integrated circuit (ASIC), field programmable gate array, or the like) communicatively coupled to memory 304 and interface 306. Memory 304 may be any form of memory capable of storing machine-executable instructions that implement one or more of the functions disclosed herein, when executed by processor 302. For example, memory 304 may be a RAM, ROM, flash memory, EPROM, EEPROM, solid-state memory device, hard drive, CD-ROM, DVD, magnetic storage device, optical storage device, other forms of non-transitory memory devices, or any combination of different memory devices.

Matching engine 100 communicates with user computer device 308 (e.g., mobile computing device 106, home computing device 110, or another computing device utilized by a user), provider computing device 116, and/or other computing devices 112 via connections 310, 312, and 314. Connections 310, 312, and 314 may be any combination of hardwired or wireless connections. For example, connection 310 may be a hardwired connection (e.g., a fiber optic connection, an Ethernet connection, a DSL connection, or the like), while connection 314 may be a wireless connection (e.g., a WiFi connection, a cellular connection, a radio-signal connection, or the like). In some embodiments, connections 310, 312, and/or 314 may be part of a shared connection with matching engine 100. For example, connections 310, 312, and/or 314 may include a single connection between matching engine 100 and the Internet or another network (e.g., a WAN, LAN, or the like). Connections 310, 312, and/or 314 may also include individual connections between user computing device 308, provider computing device 116, and other computing devices 112 and the Internet or other network.

Matching engine 100 includes interface 306, which provides one or more wired and/or wireless connections 310, 312, and 314 to user computing device 308, provider computing device 116, and/or other computing devices 112, respectively. For example, matching engine 100 may communicate information via a cellular, WiFi, radio, satellite, hardwired connection, or the like. In some cases, interface 306 may include a single interface between matching engine 100 and a network (e.g., network 101 or the like). In other cases, interface 306 may include multiple interfaces. For example, interface 306 may communicate wirelessly with provider computing device 116 via a local area network and with other computing devices 112 via an Ethernet connection to the Internet.

Memory 304 is shown to include questionnaire generator 320 which generates a user assessment questionnaire, according to some embodiments. The user assessment questionnaire includes questions that can be used to match a user to a mental health care provider. Matching engine 100 provides the user assessment questionnaire to user computing device 308 via interface 306 and connection 310. In some cases, questionnaire generator 320 may generate the questionnaire in response to a request from user computing device 308. In other cases, questionnaire generator 320 may automatically provide the user assessment questionnaire to user computing device 308. In response to receiving the user assessment questionnaire, user computing device 308 presents the questionnaire to the user, who then utilizes an interface device to answer the questionnaire. User computing device 308 then provides the user response data to matching engine 100, which stores the data as user responses 322 in memory 304.

In some embodiments, questionnaire 320 also generates a health care provider assessment questionnaire. Similar to the user assessment questionnaire, the health care provider assessment questionnaire is used to match a mental health care provider to a user. In such a case, matching engine 100 provides the health care provider assessment questionnaire to provider computing device 116 via interface 306 and connection 312. A provider utilizing provider computing device 116 then answers the health care provider assessment questionnaire via an interface device. Provider computing device 116 then transmits the provider response data to matching engine 100, which stores the data as provider responses 324 in memory 304.

Bond index score generator 328 analyzes provider responses 324 and user responses 322, in order to generate a bond index score. The bond index score provides a measure of how strong a therapeutic bond may be between a user and a mental health professional (e.g., as a number, a percentage, or the like). Bond index score generator 328 may utilize a statistical approach (e.g., using a correlation matrix or the like), a directed graph, a neural network, etc., to determine bond index scores. In some embodiments, bond index score generator 328 may also apply a weighting to one or more answers in provider responses 324 and user responses 322. Bond index score generator 328 generates bond index scores between the user responses 322 and the provider responses 324 for a plurality of providers. In some embodiments, bond index score generator 328 may also apply additional filters prior to, during, or after the generating of bond index scores, in order to further limit the set of matched health care providers. For example, bond index score generator may retrieve provider contact data 330 and filter providers eligible for matching by their proximity to the user.

Bond index score generator 328 selects one or more mental health professional having the highest bond index scores and provides an indication of the selection to a user interface of user computing device 308. In some embodiments, the user may also utilize user computing device 308 to request provider contact data 330 for a particular selected professional from matching engine 100. In other embodiments, matching engine 100 may retrieve the provider contact data 330 corresponding to the one or more providers selected by bond index score generator 328 and provide the contact data with the indication of the selection.

In some embodiments, matching engine 100 may also provide user computing device 308 with the option of initiating contact with a provider of the user's choosing. For example, when the user identifies a selected mental health professional with whom they wish to communicate, matching engine 100 may provide a number of communication options to user computing device 308. The selection of the communication option is at the discretion of the user. Each of the communication options allows the parties to exchange information in different formats. For example, communication options may include electronic mail, posting on the mental health professional's personal and secure system web page, and initiating a telephone call with the professional. Depending on the type of option selected by the user, matching engine 100 and/or user computing device 308 may initiate the communication. In some cases, the user may opt to schedule an appointment with the selected mental health professional using an on-line scheduling system (e.g., other computing devices 112) and/or register for appointment reminders (e.g., via text message, telephone call, email, automated voicemail, or contact from a pre-registered “buddy”). Such system offers available time slots for treatment, thereby allowing the user to select one or more appointments and confirm such appointment(s) online, after which the scheduling data would be transmitted via the system to the mental health professional.

Other computing devices 112 may also include a repository for a mental health professional's online presence (e.g., via a social media website, a bulletin board system, or the like). The presence may include a photograph of the mental health professional, the mental health professional's bond index, as calculated for the specific user, details of the mental health professional's educational experience and professional background, as well as other information that may be useful to the user. Maintenance of a wall (e.g., an electronic message feed system) can be at the mental health professional's option. A user may choose to perform a variety of actions from the webpage, such as post a confidential message on the wall of the provider, schedule an appointment, obtain research, take an initial psychological assessment, keep a mental health journal, measure success of a treatment, view the mental health professional's research, access homework assignments from therapy sessions, or other functions.

In one embodiment, questionnaire generator 320 may also generate a follow-up questionnaire in response to a request from user computing device 308 and provide the follow-up questionnaire to it. A follow-up questionnaire may include, for example, a private rating of the mental health professional to indicate a user's opinion of the services rendered by a particular mental health professional. The follow-up response data may be received by matching engine 100 and used to initiate a new match between the user and a different professional (e.g., if the opinion is negative). In embodiments where bond index score generator 328 employs a neural network or other adaptive process, the follow-up response data can also be used to improve the ability of matching engine 100 to generate a successful therapeutic match between a user and a mental health professional.

Parameters 326 may be used to override or control the functions of matching engine 100. For example, user computing device 308 may provide one or more parameters 326 to matching engine 100 that allow a secondary user (e.g., utilizing user computing device 308 or other computing devices 112) to access some or all of the data associated with the primary user (e.g., her user response data, the matched providers, the contact information for a provider, and the like). In another example, parameters 326 may include filters and/or weighting factors used by bond index score generator 328.

It is noted that terms such as “preferably,” “commonly,” “typically,”, and the like, when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

For the purposes of describing and defining the present disclosure it is noted that the terms “substantial”, “approximate”, and the like, are utilized herein to represent the inherent degree of uncertainty that may be attributed to any quantitative comparison, value, measurement, or other representation. The terms “substantial” and “approximate” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. The invention, therefore, as defined in the appended claims, is intended to cover all such changes and modifications as fall within the true spirit of the invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

What is claimed is:

1. A computerized method for matching a user and a mental health professional, said method comprising:
receiving, at one or more processors, user response data indicative of responses to a user assessment questionnaire by a user;
retrieving, from a memory, provider response data indicative of responses to a health care provider assessment questionnaire by a mental health professional;
using the user response data and the provider response data to generate a bond index score;
using the bond index score to select the mental health professional; and
providing an indication of the selection to a user interface device.

2. The method of claim 1, wherein the user assessment questionnaire comprises one or more questions about the user's family history, a reason the user is seeking help, a symptom experienced by the user, the user's change management style, or a reason the user may avoid seeking therapy.

3. The method of claim 1, wherein the health care provider assessment questionnaire comprises one or more questions about the mental health professional's area of expertise, how the mental health professional would encourage a patient to change their behavior, or how the mental health professional would address why the patient may avoid seeking therapy.

4. The method of claim 1, wherein one or more weighting factors are applied to the user response data.

5. The method of claim 4, wherein the bond index score is calculated by determining the correlation between the user response data and the provider response data.

6. The method of claim 1, further comprising providing contact information for the selected mental health professional to the user interface device.

7. The method of claim 6, further comprising:
receiving a request to contact the selected mental health professional, and
initiating a communication with the mental health professional, wherein the communication comprises at least one of a phone call or an electronic message.

8. The method of claim 1, further comprising authorizing an account of a second user to retrieve the selection.

9. A matching engine for matching a user and a mental health professional comprising:
one or more processors; and
a non-transitory memory operatively connected to the one or more processors, wherein said memory stores instructions that, when executed by the one or more processors, cause the one or more processors to:
receive user response data indicative of responses to a user assessment questionnaire by a user;
retrieve provider response data indicative of responses to a health care provider assessment questionnaire by a mental health professional;
generate a bond index score using the user response data and the provider response data;
use the bond index score to select the mental health professional; and
provide an indication of the selection to a user interface device.

10. The engine of claim 9, wherein the user assessment questionnaire comprises one or more questions about the user's family history, a reason the user is seeking help, a symptom experienced by the user, the user's change management style, or a reason the user may avoid seeking therapy.

11. The engine of claim 9, wherein the health care provider assessment questionnaire comprises one or more questions about the mental health professional's area of expertise, how the mental health professional would encourage a patient to change their behavior, or how the mental health professional would address why the patient may avoid seeking therapy.

12. The engine of claim 9, wherein one or more weighting factors are applied to the user response data.

13. The engine of claim 12, wherein the bond index score is calculated by determining the correlation between the user response data and the provider response data.

14. The engine of claim 9, wherein the instructions further cause the one or more processors to provide contact information for the selected mental health professional to the user interface device.

15. The engine of claim 14, wherein the instructions further cause the one or more processors to receive a request to contact the selected mental health professional and to initiate a communication with the mental health professional, wherein the communication comprises at least one of a phone call or an electronic message.

16. A non-transitory computer-readable medium comprising instructions that, when executed by one or more processors, cause the one or more processors to:
receive user response data indicative of responses to a user assessment questionnaire by a user;
receive provider response data indicative of responses to a health care provider assessment questionnaire by a mental health professional;
generate a bond index score using the user response data and the provider response data;
use the bond index score to select the mental health professional; and
provide an indication of the selection and contact information for the mental health professional to a user interface device.

17. The medium of claim 16, wherein the user assessment questionnaire comprises one or more questions about the user's family history, a reason the user is seeking help, a symptom experienced by the user, the user's change management style, or a reason the user may avoid seeking therapy.

18. The medium of claim 16, wherein the health care provider assessment questionnaire comprises one or more questions about the mental health professional's area of expertise, how the mental health professional would encourage a patient to change their behavior, or how the mental health professional would address why the patient may avoid seeking therapy.

19. The medium of claim 16, wherein one or more weighting factors are applied to the user response data.

20. The engine of claim 19, wherein the bond index score is calculated by determining the correlation between the user response data and the provider response data.
